(19) United States
(12) Patent Application Publication
(10) Pub. No.: US 2026/0370733 A1
(43) Pub. Date: Nov. 19, 2026

(54) High Speed Event Handling Mechanism in a Distributed System

(71) Applicant: DRIVENETS LTD., Raanana (IL)

(72) Inventors: Alexander ZILBERMAN, Hadera (IL); Amir BARAK, Ra'anana (IL); Idan MATITYAHU, Ramat Gan (IL)

(21) Appl. No.: 19/139,602

(22) PCT Filed: Dec. 18, 2022
(86) PCT No.: PCT/IL2022/051347

§ 371 Date: Jun. 16, 2025

(51) Int. Cl. H04L 67/63; H04L 67/10; H04L 69/22

(52) U.S. Cl. CPC H04L 67/63; H04L 67/10; H04L 69/22

(57) ABSTRACT

A method and a distributed system for use in a distributed system configured to be implemented in one or more clusters of a communication network for delivering messages within the distributed system, wherein the method and the distributed system are characterized in that the messages comprise a data payload and a header that comprises a tuple of metadata of the data payload.

### TECHNICAL FIELD

The present disclosure generally relates to the field of communication systems. More particularly, the present disclosure relates to software architecture of a high scale distributed system.

### GLOSSARY

CL—cluster leader.
CM—CLUSTER MANAGER.
EM—Element Manager, an entity which resides in all nodes of the cluster for managing the elements as required by the CM.
FCE—Forwarding Cluster Element.
FEM—Fabric Element Manager.
FM—Forwarding Manager.
FRR—Fast Re Route.
RM—Routing Manager.
WB—White-box.
Container—A container is an isolated execution environment that behaves much like a full-featured installation with its own users, file system, processes, libraries, codes, network stacks and the like. That ensures an identical behavior resulting from the software contained within such a container, irrespective of the system in which the container is being executed.
Control Plane—A logical layer that encompasses all applications related to all the functions and processes that determine which path should be used, e. g., the management of the data plane. This term encompasses among others, but not limited to, configuration engines, routing stacks, routing protocols, spanning tree, ldp (“Identity Provider”) , and user-facing services.
Data Plane—A logical layer that encompasses all functions and processes related to the forwarding of data packets/frames from one interface to another through a system. This term encompasses among others, but not limited to, routing via physical ports as well as via intermediate backplane ports to enable data packets to reach physical ports which are not immediately reachable.

### BACKGROUND

In the area of high scale distributed systems, one of the challenges in the software architecture domain, is, the ability to efficiently deliver messages to relevant system users.

Typically, distributed messaging is based on the concept of reliable message queuing. Messages are queued asynchronously between client applications and messaging systems, and such a distributed messaging system provides the benefits of reliability, scalability, and persistence.

However, as application messages grow more complex, the overhead caused by classification and forwarding decisions, becomes a important bottleneck, especially as the systems themselves scale up.

As part of managing such a distributed system composed from hundreds of nodes, each node typically forwards many messages to its cluster manager (CM). Obviously, such an operation involves a vast number of messages that reach each cluster manager from all nodes included in the respective cluster, hence there is a real need to improve the effectiveness of such an operation in order to avoid undue delays in the delivery of these messages.

Therefore, the present disclosure seeks to address the problem of efficiently delivering messages in a high scale distributed system.

### SUMMARY

The disclosure may be summarized by referring to the appended claims.

It is an object of the present disclosure to provide a novel method and a novel system that enable efficient forwarding of messages within a system being a distributed system.

It is another object of the present disclosure to provide a novel method and a novel system that enable distinguishing between important messages as opposed to regular messages, and consequently being able to handle important messages faster than regular ones.

It is another object of the present disclosure to provide a novel method and a novel system that utilize a tag based, high speed mechanism for forwarding messages in a distributed system.

Other objects of the present disclosure will become apparent from the following description.

According to a first embodiment of the present disclosure there is provided a method for use in a distributed system configured to be implemented in one or more clusters of a communication network for delivering messages within the distributed system, wherein the method is characterized in that the messages comprise a data payload and a header that comprises a tuple of metadata of the data payload.

The term “tuple” as used herein throughout the specification and claims is used to denote a finite sequence of terms, e.g., a single row in a relational database.

The term “metadata” as used herein throughout the specification and claims, is used to denote data that provides information about other data but not the content of the data, such as the text of a message or an image itself. In an embodiment of the solution provided by the present disclosure, the metadata comprises at least one member of a group that consists of a target, a source, an event type (i.e., the classification of the event) and an event related data.

According to another embodiment, the metadata comprises at least one member of a group that consists of a target; a source; an event type; and an event related data.

In accordance with another embodiment, each of the at least one member of the group has a binary value, thereby the header is suited to provide an indication regarding whether a message is an important message or not.

By yet another embodiment, each of the one or more clusters comprises a cluster manager configured to determine whether a message is an important message or not, based on value of one or more of the at least one member included in said group. That may be done for example, if one of the members in the group is defined as a member that has a higher weight than any of other members, e.g., if the value of the event type in the message header is “1” whereas all other members of the group have the value “0”, the message will still be handled is such a case as an important message. Alternatively, if for example two or more members such as the event related data member and the target member have each the value of “1” while the other two members have the value of “0”, still, the system operational definition may be such that the message will still be considered as an important message. Obviously. If all four members have the value of “1”, the message will be considered an important message.

By still another embodiment of the present disclosure, in case the message has been determined as being an important message, it will be conveyed without further processing, for example it will be forwarded or relayed, as required, without further inspection of the message header and without parsing the message to retrieve its data payload therefrom.

According to another aspect of the present disclosure, there is provided a distributed system for use in a communication network, said distributed system comprises a plurality of nodes arranged in a form of a plurality of clusters, and configured to deliver messages within said distributed system, wherein said distributed system is characterized in that said messages comprise a data payload and a header, and wherein said header comprises a tuple of metadata associated with said data payload. In accordance with another embodiment of this aspect of the disclosure, the metadata enables determining how a message associated therewith, will be handled.

By yet another embodiment of this aspect, the metadata comprises at least one member of a group that consists of a target, a source, an event type and an event related data.

According to still another embodiment, each of the at least one member of said group has a binary value.

In accordance with another embodiment, each of the one or more clusters comprise a cluster manager configured to determine whether a message is an important message or not, based on value of one or more of the at least one member included in that group.

By still another embodiment of this aspect of the disclosure, the cluster manager is configured to determine whether a message is an important message or not based on the value of the event type member.

According to yet another embodiment of this aspect of the disclosure, in case the message has been determined as being an important message, the message will be forwarded without further processing.

### BRIEF DESCRIPTION OF THE DRAWINGS

The accompanying drawing, which is incorporated herein and constitute a part of this specification, illustrates an embodiment of the disclosure and, together with the description, serve to explain the principles of the embodiments disclosed herein.

FIG. 1 illustrates a partial view of a distributed system, wherein important messages are separated from regular messages, construed in accordance with an embodiment of the present invention; and

FIG. 2 illustrates a flow chart, exemplifying a method for carrying out the present solution according to an embodiment construed in accordance with the present invention.

### DESCRIPTION OF EXEMPLARY EMBODIMENTS

Some of the specific details and values in the following detailed £ description refer to certain examples of the disclosure. However, this description is provided only by way of example and is not intended to limit the scope of the invention in any way. As will be appreciated by those skilled in the art, the claimed distributed routing system may be implemented by using other devices that are known in the art per se. The scope of the invention can be summarized by referring to the appended claims.

As part of managing a distributed system in a communication network which is composed from hundreds of nodes, optionally white boxes, each node typically forwards (streams) messages to its cluster manager (CM). Obviously, such an operation involves a vast number of messages that reach each cluster manager, hence there is a real need to improve the effectiveness of this operation in order to avoid undue delays in the system′ s operation. The solution provided by the present invention is based on distinguishing between important messages vis. regular messages, and to enable handling (e. g., forwarding) the important messages faster than regular ones.

According to an embodiment of the present invention a novel mechanism of structured binary tag messages that are being forwarded across the system, is used.

This prefix (tag) attached to the message comprises metadata of the message's data payload, and comprises at least one member of a group that consists of a target to which the message needs to be forwarded, a source where the message was generated, type of an event associated with that message and related data of that event.

In accordance with an embodiment of the disclosure, each of the members discussed above which are comprised in the metadata, simply indicate if the message is an important message or not. That may be done for example, per the system operator's decision, if one of the members in the group is defined as a member that has a higher weight than any of other members, e. g., if the value of the event type in the message header is “1” whereas all other members of the group have the value “0”, the message will still be handled is such a case as an important message. Alternatively, if the system operator′ decision is that for example two or more members such as the event related data member and the target member have each the value of “1” while the other two members have the value of “0”, still, the system operational definition may be such that the message will still be considered as an important message. Obviously. If all four members have the value of “1”, the message will be considered an important message.

By introducing such a structured binary tag as a prefix to the message payload, it becomes possible to quickly identify parameters such as targets of the messages being delivered, types of the events associated with the messages being delivered, etc. This in turn enables distinguishing between important messages and regular messages and forwarding and/or relaying the important messages without the need to deserialize applicative content.

Messages that are classified as important messages, will be conveyed immediately, without additional inspection and parsing of the message and its data payload. The classification of a message as an important message or as a regular message, may be done according to the value of any one of the constituents of the metadata prefix or any combination thereof, as pre-defined by the system configuration or determined by the system's operator.

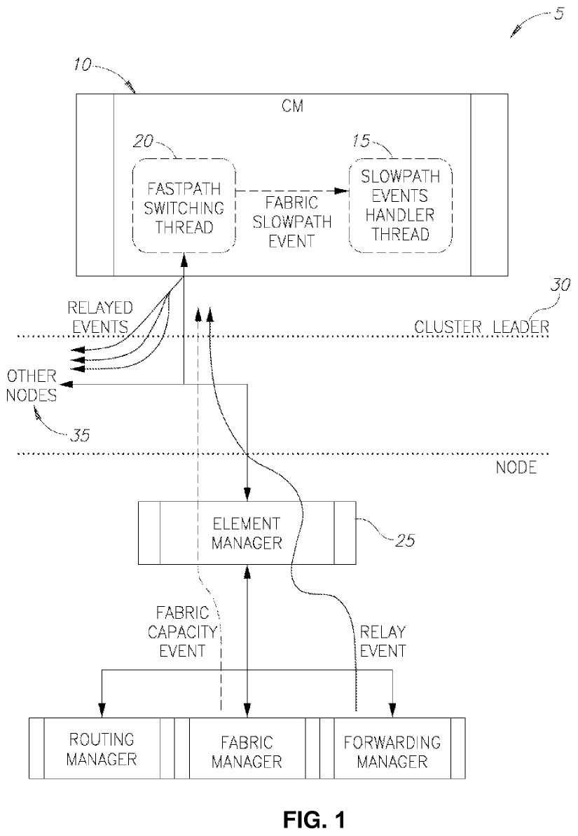

FIG. 1 illustrates a partial view of a distributed system 5, wherein important messages are separated from regular messages, construed in accordance with an embodiment of the present invention. The regular messages are forwarded along a “slowpath” for non-urgent events (associated with regular messages) as opposed to a path for handling messages associated with events marked for relay (forwarding without further processing).

Events of the two types discussed above are forwarded to cluster manager 10 (CM). Information that relates to these events is forwarded by using messages generated by an application, which then sends respective messages with their metadata-tagged events comprised in the messages' headers. The messages are sent towards the local node's element manager (EM) 25 that resides within a cluster leader 30 (CL), and element manager 25 then forwards them to the CM 10 connection. In the CM 20, the message is classified based on the information included in the respective message header. If the values included in the metadata indicates that the event is important and therefore the message has to be conveyed without further processing. Once it is determined that the message (and respectively the event associated therewith) is an important message or a regular message, the thread 20 that receives the events relays it to the relay event path (i.e., for the important messages) and then to other nodes 35, or forwards the regular messages to the internal fabric capacity event path 15, as demonstrated in FIG. 1.

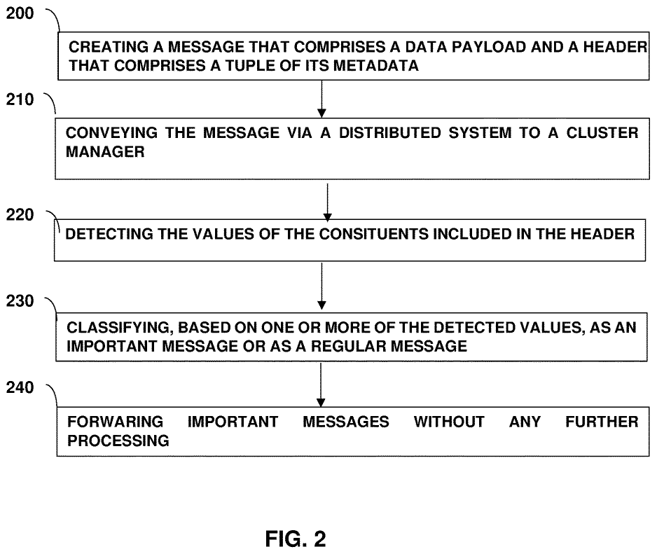

FIG. 2 illustrates a flow chart, exemplifying a method for carrying out the present solution according to an embodiment construed in accordance with the present invention.

In step 200 a message is created to be conveyed via a distributed system operating in a communication network, wherein the message comprises a data payload, and a header comprises a tuple of its metadata—target, source, event type and event data.

Next, the message is conveyed via the distributed system and arrives at a cluster manager (step 210).

The cluster manager and detects the values of the constituents included in header (step 220) and classifies, based on one or more of these values, depending on the system operator's decision, the message as an important message or as a regular message (step 230).

If the cluster manager determines that the message is an important message conveying the message without any further processing of the message, towards its destination without undue delay (step 240). Optionally, the classification ability by the cluster manager side by inspecting the event type. Events, which are tagged as having a type that requires to be relayed immediately, will be forwarded without additional inspection and parsing.

By virtue of the exemplified method, messages associated with events may be forwarded, relayed, and handled more efficiently and at a greater capacity. In other words, the consequence of the above method leads to a better resolution of the event handling, leading to a more optimal and fast event handling.

The present invention has been described using detailed descriptions of embodiments thereof that are provided by way of example and are not intended to limit the scope of the invention in any way. The described embodiments comprise different features, not all of which are required in all embodiments of the invention. Some embodiments of the present invention utilize only some of the features or possible combinations of the features. Variations of embodiments of the present invention that are described and embodiments of the present invention comprising different combinations of features noted in the described embodiments will occur to persons of the art. The scope of the invention is limited only by the following claims.

1. A method for use in a distributed system configured to be implemented in one or more clusters of a communication network for delivering messages within the distributed system, wherein the method is characterized in that the messages comprise a data payload and a header that comprises a tuple of metadata of the data payload.

2. The method of claim 1, wherein said metadata enables determining how a message associated therewith, will be handled.

3. The method of claim 1, wherein said metadata comprises at least one member of a group that consists of a target, a source, an event type and an event related data.

4. The method of claim 2, wherein each of said at least one member of said group has a binary value.

5. The method of claim 2, wherein each of said one or more clusters comprise a cluster manager configured to determine whether a message is an important message or not, based on value of one or more of the at least one member included in said group.

6. The method of claim 5, wherein said cluster manager is configured determine whether a message is an important message or not based on the value of the event type member.

7. The method of claim 5, wherein in case the message has been determined as being an important message, the message will be forwarded without further processing.

8. A distributed system for use in a communication network, said distributed system comprises a plurality of nodes arranged in a form of a plurality of clusters, and configured to deliver messages within said distributed system, wherein said distributed system is characterized in that said messages comprise a data payload and a header, and wherein said header comprises a tuple of metadata associated with said data payload.

9. The distributed system of claim 8, wherein said metadata enables determining how a message associated therewith, will be handled.

10. The distributed system of claim 8, wherein said metadata comprises at least one member of a group that consists of a target, a source, an event type and an event related data.

11. The distributed system of claim 9, wherein each of said at least one member of said group has a binary value.

12. The distributed system of claim 9, wherein each of said one or more clusters comprise a cluster manager configured to determine whether a message is an important message or not, based on value of one or more of the at least one member included in said group.

13. The distributed system 12, wherein said cluster manager is configured to determine whether a message is an important message or not based on the value of the event type member.

14. The method of claim 12, wherein in case the message has been determined as being an important message, the message will be forwarded without further processing.
